(19) United States
(12) Patent Application Publication
(10) Pub. No.: US 2026/0331891 A1
(43) Pub. Date: Oct. 22, 2026

(54) HOT ARM CLAMPING SYSTEM

(71) Applicants: SEEKELLS INNOVATIONS, LLC, Kuna, ID (US); META DESIGN & MANUFACTURING, INC., Vallejo, CA (US)

(72) Inventors: Robert SEEKELL, Kuna, ID (US); James Coleman, Vallejo, CA (US); Bradley Sykes, Vallejo, CA (US)

(73) Assignees: SEEKELLS INNOVATIONS, LLC, Kuna, ID (US); META DESIGN & MANUFACTURING, INC., Vallejo, CA (US)

(21) Appl. No.: 19/554,596

(22) Filed: Mar. 2, 2026

Related U.S. Application Data
(60) Provisional application No. 63/765,453, filed on Feb. 28, 2025.

(51) Int. Cl. H02G 7/05

(52) U.S. Cl. CPC H02G 7/05

(57) ABSTRACT

The present invention provides an advanced clamping hot arm system having an adaptive clamping device. The clamping device is adaptively, slidably, and pivotably mounted to a hot arm and includes movable clamping arms driven by a common shaft having left-hand and right-hand threading therein with respective threaded carrier nuts. An additional adaptive bail mount bracket may be included and allows for a common mount with the pin mount bracket on the hot arm. The bail mount bracket has a pivotable bail shape that pivotably engages with a cross arm. The pin mount bracket is slidably engageable with a rigging hole extending from a standoff arm. Multiple adaptive clamping devices may be mounted on a hot arm.

### CROSS-REFERENCE TO RELATED APPLICATIONS

This application relates to, and claims priority from U.S. Prov. Ser. No. 63/765,453 filed Feb. 28, 2025, the entire contents of which are incorporated fully by reference as if the contents are set forth verbatim herein.

### STATEMENT REGARDING FEDERALLY SPONSORED RESEARCH OR DEVELOPMENT

Not applicable

### BACKGROUND OF THE INVENTION

This section of this document introduces various information from the art that may be related to or provide context for some aspects of the technique described herein and/or claimed below. It provides background information to facilitate a better understanding of that which is disclosed herein. This is a discussion of “related” art. That such art is related in no way implies that it is also “prior” art. The related art may or may not be prior art. The discussion in this section is to be read in this light, and not as admissions of prior art.

### Field of the Invention

The present invention provides an advanced clamping hot arm system providing adaptive embodiments to aid in the temporary transfer of energized conductors during maintenance or repair to the outside of a pole attached to a cross arm or standoff arm. More particularly the present invention provides an advanced clamping hot arm system that is adaptive to releasably secure to both conductor standoff supports and conductor cross arm supports with increased safety, security, in a non-damaging manner to conductor system components. Still more particularly, the present invention provides an advanced clamping hot arm system that provides an adaptive clamping device and a combined adaptive bail mount system and an adaptive pin mount system.

### Description of the Related Art

Line workers are highly trained technicians that routinely complete arduous maintenance and repair tasks within a high voltage and current environment.

Electrical power distribution lines extend and network throughout the United States and in other jurisdictions. The typical voltage of a distribution circuit is anywhere from 4 KV (4000 volts) to 35 KV (35,000 volts) and related sub-transmission lines carry voltage to distribution substations, end customers, or as may be otherwise needed. These sub-transmission voltages are anywhere from 34.5 KV up to 69 KV, or more depending upon need. Sub-transmission lines are also used to send power to regional distribution substations where the voltage is reduced to a designated distribution voltage that transfers out and extends into the distribution network for homes and businesses. The distribution voltage leaves the distribution substations and travels on energized aluminum or copper conductors arranged, normally, 3 or 4 per circuit on a wooden or fiberglass utility crossarm.

Conventionally, when the line workers need to install new conductors, for work on a utility crossarm or standoff arm, the energized conductors need to be moved out of the work area to create a safer work environment. The insulators that hold the energized conductors on the utility crossarms and standoff arms keep the current flow isolated from the crossarm and pole to prevent fires or arc flashes. When the utility company needs to remove the energized conductor off the insulators or crossarm or standoff arm they need a safe position to temporarily hold the energized conductor. The conventional temporary hot arms are made from non-conductive materials that have wire holders attached and support the conductor firmly in place and are thus attached to the conventional temporary hot arm.

Unfortunately, there have been many cases around the United states where a line worker, working close to an energized conductor occasionally contacts an energized conductor causing an arc flash which can be harmful or fatal. An arc flash is a situation where flashover of electric current leaves its intended path and travels through the air from one conductor to another or to ground. These events injure workers in industry.

Conventionally, the United States has used wooden crossarms since the early 1920s. Most of the wood cross arms have been treated Douglas or southern yellow pine. The United States has increasingly adapted fiberglass cross arms primarily due to their superior durability and longevity compared to traditional wooden cross arms. The new fiberglass arms are resistant to weather damage, rot, insect infestations, and fire. They provide better electrical insulation and have a much longer service life than wood cross arms. The fiberglass material is also better for the environment for not needing so many trees cut down for the old style wooden crossarms. Accordingly, line workers are increasingly encountering fiberglass crossarms during repair work.

Unfortunately, conventional temporary hot arms that are being used in the trade today when mounted under the utility crossarm are damaging the new fiberglass arms. Conventional hot arms use an attachment mechanism in the form of sharp screw spikes that are turned (threaded) into the fiberglass (or wood) to fix the conventional temporary hot arm in place. With this type of attachment, the conventional temporary hot arm is damaging existing equipment, shortening lift-span, and causing damage.

As a further detriment, the conventional temporary hot arms today do not mount at all to the small round-shaped utility arms, or round-shaped standoff arms that utilities are using at this time.

The present invention is directed to resolving, or at least reducing, one or all of the problems mentioned above.

### ASPECTS AND SUMMARY OF THE INVENTION

According to the present disclosure there is provided an advanced clamping hot arm system that is operative with both standoff bracket conductor mounts and cross arm conductor mounts.

In one aspect of the present invention, there is provided an advanced clamping hot arm system having an adaptive clamping device and a combined adaptive bail mount bracket and a pin mount bracket. The clamping device is adaptively, slidably, and pivotably mounted to a hot arm and includes movable clamping arms driven by a common shaft having left-hand and right-hand threading therein with respective carrier nuts. The adaptive bail mount bracket has a common mount with the pin mount bracket on the hot arm. The bail mount bracket has a pivotable bail shape that pivotably engages with a cross arm. The pin mount bracket is slidably engageable with a rigging hole extending from a standoff arm.

According to another aspect of the present invention provides an advanced clamping hot arm system, as shown and discussed herein.

Another alternative aspect of the present invention provides a method for operating an advanced clamping hot arm system, using the steps as shown and discussed herein.

According to another adaptive and alternative aspect of the present invention, there is provided an advanced clamping hot arm system that is easily adaptive to alternative and modified configurations, may be operated and fixed in place using conventional impact drivers, battery-powered impact drivers, battery-powered non-impact drivers, pneumatic hand tools, and allow for less user-strain and injury avoiding repetitive movements.

According to another adaptive and alternative aspect of the present invention, there is provided an advanced clamping hot arm system that is lightweight in use and is ergonomic in design so as to improve user safety and minimize workplace injury.

According to another adaptive and alternative aspect of the present invention, there is provided an advanced clamping hot arm system that easily operates to engage, hold, and arrange for operation with a wide range of conductor (e.g., energized conductor) weights and thicknesses and which also easily operates to function with a wide range of insulator shapes, forms, weights, and materials.

According to another adaptive and alternative aspect of the present invention, there is provided an advanced clamping hot arm system where a round tube, constructed preferably of nonconductive material and may be formed as a fiberglass round member filled with a non-conductive foam that is preferably nonporous. The hot arm optionally has sealed ends to prevent moisture intake and the sealed ends may be endcaps constructed from a nonconductive material such as fiberglass, but may be steel, plastic, carbon fiber, rubber, or any elastomer or wood, or may be any modified multi-layered structure (e.g., insulation coated metal or elastomer coated fiberglass etc.). The preferred hot arm shape is provided as a fiberglass shaft length from approximately 3 feet to 8 feet long, but is not restricted thereto and may be longer depending upon a needed use application. The outer diameter of the hot arm is ideally round having a diameter of 2.5 inch or three inches in size but may be any suitable dimension or shape (e.g., round, ovoidal, polygonal, rectilinear or otherwise). As suggested below fiber-glass round nonconductive shaft for the hot arm is provided for temporary affixing attachment below the utility crossarm or standoff arm that may have any shape but is typically a rectangular shape or round shape each of different sizes. When attached to the utility arm the hot arm will be mounted at a horizontal or upward tilted position facing outward on the end of the utility crossarm or standoff arm so that a clamping, security, and weight (gravity) will maintain a stable position. The orientation may be adaptively repositioned (at any suitable angle between horizontal (zero degrees) and a full upright angle (perpendicular or ninety degrees) without departing from the scope of the present invention).

It will be further understood that the phrase ‘elastomer’ will refer to a solid material at standard temperature and pressure (STP) having elastic properties to compress and rebound under a pressure force and is conventionally constructed from a natural or synthetic polymer having elastic properties, and this will be fully understood by those of skill in the art without the need to refer to other properties or hardness measurements.

According to another adaptive and alternative aspect of the present invention, there is provided an advanced clamping hot arm system with a nonconductive fiberglass hot arm that may further include one or more conventional conductor (wire) holders sized to securely receive an energized conductor during a repair operation. These convention wire holders include top mounted wire holders (shown) but may adaptively include bottom mounted wire holders or side mounted wire holders that can attach insulators for higher voltages.

According to another adaptive and alternative aspect of the present invention, there is provided an advanced clamping hot arm system with wherein mounted on the horizontal shaft hot arm is an adaptive bail mount bracket, of any suitable material including fiberglass, steel, aluminum, etc. that is shaped to pivot from an upright position for use to a retracted position between uses aligned horizontally to the hit arm. When in the bail mount of the adaptive bail mount bracket is in the retracted/folded down position an adaptive pin mount system is exposed for pining to a crossarm or a standoff arm utilizing a suitably shaped pin (e.g., ½ inch to ¾ inch dia. pin). This adaptive arrangement provides an advanced clamping hot arm system with two options to either rest on the end of the utility arm (using the adaptive bail mount bracket) or pin into a rigging hole on the bottom of the utility arm or pin into a rigging hole on the bottom of the utility arm or pin into a rigging hole on the bottom of the utility arm (using the adaptive pin mount system). This arrangement is readily adapted to secure to the hot arm and can be releasably adapted along a length at any suitable position, can be rotated at an angular position different from the adaptive clamping device or the convention wire holder) (e.g., along a length, or rotated in a radius about an outer diameter).

According to another adaptive and alternative aspect of the present invention, there is provided an advanced clamping hot arm system wherein the adaptive clamping device includes squeeze mechanism or a pressure-applying-mechanism that allows two opposed arms or members to travel relative to each other (e.g., along an X-direction back-and-forth) and so grip (compress or release) the cross arm or standoff arm. The two small arms may have replaceable elastomeric or rubber inserts they can be rubber or optionally fiberglass or any suitable plastic or elastomeric or polymeric (made from a polymer) material or a combination of any of these, and may optionally include a cellulose material (e.g., wood, wood fiber, wood-and-plastic composite), and may further include construction from any non-conductive material. The distance of travel is preferably from approximately 1½ to 6 inches but may be any suitable distance/amount to secure the hot arm to the cross arm or standoff arm as will be discussed and as will be understood by one of skill in this art having appreciated the complete disclosure herein. The adaptive clamping system operates preferably with opposing left-hand and right-hand threaded shafts or a threaded axle and suitably threaded carrier nuts driving the jaws but alternative mechanisms and structures may be employed without departing from the invention. The end of the threaded shaft is drivable by an electric, pneumatic, or other drive manner for force application. Between the opposed two small arms is preferably a non-conductive material such as rubber, plastic, or wood so that no conductive connection with the cross arm or standoff arm is made.

As a further alternative and adaptive embodiment a further version of the clamping system may include jaws that allow the jaws to go back and forth (along an X-direction) relative to each other and a cross arm or standoff arm but may include additional structures that allow portions of the jaws to travel toward-or-away from (along a Y-direction) the hot arm, cross arm, or stand off arm, and in this manner the clamping system may grip the hot arm, cross arm, or stand off arm in multiple (X, Y, or X-and-Y) directions and by axial-pivoting at multiple arrangements, without departing from the scope and spirit of the present invention.

According to an adaptive and alternative embodiment of the present invention there is provided an advanced clamping hot arm system, comprising: an elongate hot arm having a proximate end and an opposite distal end, an adaptive clamping device on the distal end, a wire holder on the proximate end, at least one of an adaptive bail mount system and an adaptive pin mount system on the elongate hot arm between adaptive clamping device and the wire holder.

According to another adaptive and alternative embodiment of the present invention, there is provided an advanced clamping hot arm system, wherein: the adaptive clamping device has a jaw assembly driving a pair of opposing jaws relative to each other.

According to another adaptive and alternative embodiment of the present invention, there is provided an advanced clamping hot arm system, wherein: the adaptive bail mount system includes a bail bracket that is adaptively mounted and operably moveable relative to the elongate hot harm.

According to another adaptive and alternative embodiment of the present invention, there is provided an advanced clamping hot arm system, wherein: the adaptive pin mount system includes a sliding pin that is adaptively mounted and operably movable relative to the elongate hot arm.

All elements of the proposed invention may be removed, disassembled, and cleaned, which also enables testing and certification between uses as may be desired.

According to another adaptive and alternative embodiment of the pre sent invention, there is provided an advanced clamping hot arm system that uses a squeeze mechanism to tighten and loosen a clamping arrangement and that mounts with a bail bracket arrangement, a pin mount arrangement, or a latch mount arrangement in any suitable combination.

According to another adaptive and alternative embodiment of the pre sent invention, there is provided an advanced clamping hot arm system that is mountable to a utility support crossarm arrangement or to a utility support standoff arm arrangement, and that may be disassembled fully during a cleaning or an inspection and which is adaptable and adjustable to different positions with different hole patterns.

According to another adaptive and alternative embodiment of the present invention, there is provided an advanced clamping hot arm system that temporarily mounts to one or a variety of utility cross arms including dead-end cross arms, wherein the clamping mechanism rapidly clamps to rectangular or cylindrical shapes with a rotational input by hand or electric drill, or with a pivot latch or clamping mechanism, and wherein the clamping operation works from either side of the mechanism and optionally only needs to work from one side.

According to another adaptive alternative embodiment of the present invention the clamping mechanism simultaneously squeezes in both an X-and-a-Y direction with only one rotational input enabling it to rapidly secure to different sized shapes, including polygonal, rectangular shapes. According to another alternative aspect of the present invention there is a hot arm that that can quickly mount under all sizes of utility crossarms, dead end cross arms, or standoff brackets, or where a hot arm may use removable end clamp attachments and which may be suitable for disassembly, inspection, and cleaning, and where a hot arm assembly may include an eye nut or rigging hole.

A further alternative adaptive alternative aspect of the present invention provides a temporary hot arm that has a bracket that can add further support and attach a non-conductive brace of different lengths to help support downward forces.

According to another alternative and adaptive aspect of the present invention, there is provided a clamping hot arm system, for engaging a cross arm, comprising: an adaptive clamping device, further comprising: an adjustable jaw assembly having a first jaw member and a second jaw member, a driving axle extending along a first pivot axis through a contact support surface between the first jaw member and the second jaw member, the driving axle having a left-hand threaded section and a right-hand threaded section, a first threaded carrier in the first jaw member driven by the left-hand threaded section and a second threaded carrier in the second jaw member driven by the right-hand threaded section whereby a rotation of the driving axle drives an opening or a closing of the adjustable jaw assembly, and each the first jaw member and the second jaw member, further comprising: a jaw bottom and a jaw top, the jaw top slidably secured to the jaw bottom along a slide channel between an extended position and an engagement position, the jaw top having an extension perpendicular to the jaw bottom, a jaw spring on an outer side of the jaw top opposite the contact support surface joining the jaw bottom and the jaw top and urging the extension on the jaw top toward the contact support surface, a tooth rack having a plurality of teeth along an inner side of the jaw top opposite the jaw spring, a pivoting pawl on the jaw bottom having a pawl pivot, the pivoting pawl having a pin side with a pin profile and an opposed a tooth side with a tooth profile pivotable about the pawl pivot, and a pawl spring on the pivoting pawl urging a pawl contact surface toward the contact support surface between the first jaw member and the second jaw member whereby pin profile releasably engages the plurality of teeth on the tooth rack and restrains the jaw top in the extended position resisting the jaw spring.

According to another alternative and adaptive aspect of the present invention, there is provided a clamping hot arm system, wherein: the pivoting pawl is pivotable about the pawl pivot to compress the pawl spring and to release the pin profile from the plurality of teeth on the jaw top, whereby the jaw spring urges the extension on the top jaw to the engagement position.

According to another alternative and adaptive aspect of the present invention, there is provided a clamping hot arm system, wherein: the tooth profile on the pivoting pawl releasably engages with the tooth rack on the inner side of the jaw top at the engagement position thereby preventing the jaw top from moving away from the contact support surface.

According to another alternative and adaptive aspect of the present invention, there is provided a clamping hot arm system, further comprising: a jaw side contact member on each the jaw bottom projecting toward the contact support surface, and the jaw side contact member being an electrically resistive material.

According to another alternative and adaptive aspect of the present invention, there is provided a clamping hot arm system, further comprising: a jaw top contact member on each the extension of each the jaw top projecting toward the contact support surface, and the jaw top contact member being an electrically resistive material.

According to another alternative and adaptive aspect of the present invention, there is provided a clamping hot arm system, further comprising: a jaw side contact member on each the jaw bottom projecting toward the contact support surface, the jaw side contact member being an elastomeric material, a jaw top contact member on each the extension of each the jaw top projecting toward the contact support surface, and the jaw top contact member being an elastomeric material.

According to another alternative and adaptive aspect of the present invention, there is provided a clamping hot arm system, wherein: the pawl contact surface on the pivoting pawl is a convex curved surface projecting away from the tooth side and from the tooth profile.

According to another alternative and adaptive aspect of the present invention, there is provided a clamping hot arm system, wherein: the pin profile projects in a first direction and the tooth profile projects in a second direction and the first direction and the second direction form an acute angle with a vertex on the same side of the pawl pivot as the pawl contact surface, and whereby when the pivoting pawl pivots from an engagement of the tooth rack with the pin profile to an engagement of the tooth rack with tooth profile, the jaw spring urges the jaw top to slide between the extended position and the engagement position.

According to another alternative and adaptive aspect of the present invention, there is provided a clamping hot arm system, further comprising: a pair of opposed driving ends on respective opposing sides of the driving axel, and each the driving end having an engagement profile for an engagement and applying of a rotational drive force about the driving axel whereby the rotation of the driving axle drives the opening or the closing of the adjustable jaw assembly.

According to another alternative and adaptive aspect of the present invention, there is provided a clamping hot arm system, further comprising: a hot arm mounting assembly, the hot arm mounting assembly pivotably secured to the adaptive clamping device and releasably securable movable between an engagement position and a storage position.

According to another alternative and adaptive aspect of the present invention, there is provided a clamping hot arm system, further comprises: an adjustable hinged bracket having a first and a second mounting portion pivotably secured at a first side, a threaded bolt on the first mounting portion opposite the first side, the threaded bolt pivotably engaging with the second mounting portion opposite the first side in an interference fit, and a retaining member on the threaded bolt engaging with the second mounting portion to secure the hot arm mounting assembly between an open and a closed position.

According to another alternative and adaptive aspect of the present invention, there is provided a clamping hot arm system, wherein: the hot arm mounting assembly, further comprises: a slidable mount having a continuous bounded member shaped for receiving a hot arm, and the continuous bounded member having a plurality of bounded openings therethrough providing an access from an exterior of the continuous bounded member to an interior of the continuous bounded member.

According to another alternative and adaptive aspect of the present invention, there is provided a clamping hot arm system, wherein: the hot arm mounting assembly, further comprises: a first retaining split ring and a second retaining split ring having a common axis and joined by a cross mount, and the cross mount pivotably joined to the adaptive clamping device and pivotable in a first pivot axis perpendicular to the common axis.

According to another alternative and adaptive aspect of the present invention, there is provided a clamping hot arm system, for engaging a cross arm, comprising: an adaptive clamping device, further comprising: an adjustable jaw assembly having a first jaw member and a second jaw member, a driving axle extending along a first pivot axis through a contact support surface between the first jaw member and the second jaw member, the driving axle having a left-hand threaded section and a right-hand threaded section, a first threaded carrier in the first jaw member driven by the left-hand threaded section and a second threaded carrier in the second jaw member driven by the right-hand threaded section whereby a rotation of the driving axle drives an opening or a closing of the adjustable jaw assembly, and each the first jaw member and the second jaw member, further comprising: a jaw bottom and a jaw top, the jaw top slidably secured to the jaw bottom along a slide channel between an extended position and an engagement position, the jaw top having an extension perpendicular to the jaw bottom, a jaw spring on an outer side of the jaw top opposite the contact support surface joining the jaw bottom and the jaw top and urging the extension on the jaw top toward the contact support surface, a tooth rack having a plurality of teeth along an inner side of the jaw top opposite the jaw spring, a pivoting pawl on the jaw bottom having a pawl pivot, the pivoting pawl having a pin side with a pin profile and an opposed a tooth side with a tooth profile pivotable about the pawl pivot, a pawl spring on the pivoting pawl urging a pawl contact surface toward the contact support surface between the first jaw member and the second jaw member whereby pin profile releasably engages the plurality of teeth on the tooth rack and restrains the jaw top in the extended position resisting the jaw spring, the pivoting pawl is pivotable about the pawl pivot to compress the pawl spring and to release the pin profile from the plurality of teeth on the jaw top, whereby the jaw spring urges the extension on the top jaw to the engagement position, and the tooth profile on the pivoting pawl releasably engages with the tooth rack on the inner side of the jaw top at the engagement position and prevents the jaw top from moving away from the contact support surface.

According to another alternative and adaptive aspect of the present invention, there is provided a clamping hot arm system, wherein: the pawl contact surface on the pivoting pawl is a convex curved surface projecting away from the tooth side and from the tooth profile.

According to another alternative and adaptive aspect of the present invention, there is provided a clamping hot arm system, wherein: the pin profile projects in a first direction and the tooth profile projects in a second direction and the first direction and the second direction form an acute angle with a vertex on the same side of the pawl pivot as the pawl contact surface, and whereby when the pivoting pawl pivots from an engagement of the tooth rack with the pin profile to an engagement of the tooth rack with tooth profile, the jaw spring urges the jaw top to slide between the extended position and the engagement position.

According to another alternative and adaptive aspect of the present invention, there is provided a clamping hot arm system, further comprising: a pair of opposed driving ends on respective opposing sides of the driving axel, and each the driving end having an engagement profile for an engagement and applying of a rotational drive force about the driving axel whereby the rotation of the driving axle drives the opening or the closing of the adjustable jaw assembly.

According to another alternative and adaptive aspect of the present invention, there is provided a clamping hot arm system, for engaging a cross arm, comprising: an adaptive clamping device, further comprising: an adjustable jaw assembly having a first jaw member and a second jaw member, a driving axle extending along a first pivot axis through a contact support surface between the first jaw member and the second jaw member, the driving axle having a left-hand threaded section and a right-hand threaded section, a first threaded carrier in the first jaw member driven by the left-hand threaded section and a second threaded carrier in the second jaw member driven by the right-hand threaded section whereby a rotation of the driving axle drives an opening or a closing of the adjustable jaw assembly, and each the first jaw member and the second jaw member, further comprising: a jaw bottom and a jaw top, the jaw top slidably secured to the jaw bottom along a slide channel between an extended position and an engagement position, the jaw top having an extension perpendicular to the jaw bottom, a jaw spring on an outer side of the jaw top opposite the contact support surface joining the jaw bottom and the jaw top and urging the extension on the jaw top toward the contact support surface, a tooth rack having a plurality of teeth along an inner side of the jaw top opposite the jaw spring, a pivoting pawl on the jaw bottom having a pawl pivot, the pivoting pawl having a pin side with a pin profile and an opposed a tooth side with a tooth profile pivotable about the pawl pivot, a pawl spring on the pivoting pawl urging a pawl contact surface toward the contact support surface between the first jaw member and the second jaw member whereby pin profile releasably engages the plurality of teeth on the tooth rack and restrains the jaw top in the extended position resisting the jaw spring, the pivoting pawl is pivotable about the pawl pivot to compress the pawl spring and to release the pin profile from the plurality of teeth on the jaw top, whereby the jaw spring urges the extension on the top jaw to the engagement position, the tooth profile on the pivoting pawl releasably engages with the tooth rack on the inner side of the jaw top at the engagement position and prevents the jaw top from moving away from the contact support surface, wherein the pawl contact surface on the pivoting pawl is a convex curved surface projecting away from the tooth side and from the tooth profile, the pin profile projects in a first direction and the tooth profile projects in a second direction and the first direction and the second direction form an acute angle with a vertex on the same side of the pawl pivot as the pawl contact surface, and whereby when the pivoting pawl pivots from an engagement of the tooth rack with the pin profile to an engagement of the tooth rack with tooth profile, the jaw spring urges the jaw top to slide between the extended position and the engagement position.

According to another alternative and adaptive aspect of the present invention, there is provided a clamping hot arm system, for engaging a cross arm, comprising: at least one adaptive clamping device, further comprising: an adjustable jaw assembly having a first jaw member and a second jaw member, a driving axle extending along a first pivot axis through a contact support surface between the first jaw member and the second jaw member, the driving axle having a left-hand threaded section and a right-hand threaded section, a first threaded carrier in the first jaw member driven by the left-hand threaded section and a second threaded carrier in the second jaw member driven by the right-hand threaded section whereby a rotation of the driving axle drives an opening or a closing of the adjustable jaw assembly, and each the first jaw member and the second jaw member, further comprising: a jaw contact surface projecting toward the contact support surface, the jaw contact surface includes an electrically resistive material, an elongate hot arm member having a first end and a second end, at least one hot arm mounting assembly, the hot arm mounting assembly releasably securing the at least one adaptive clamping device to the hot arm member proximate the first end.

According to another alternative and adaptive aspect of the present invention, there is provided a clamping hot arm system, wherein: the hot arm mounting assembly has an adjustable pivot axis system that pivots the adaptive clamping device relative to the elongate hot arm member between an engagement position and a storage position.

According to another alternative and adaptive aspect of the present invention, there is provided a clamping hot arm system, wherein: each the jaw member, further comprises: a jaw bracket extension projecting upwardly along the jaw contact surface, a plurality of openings in the jaw bracket arrayed at a plurality of distances from the contact support surface and the driving axle, and whereby a bolt in the adaptive clamping device is selectively positionable and repositionable at respective opposed openings extending between opposed jaw bracket extension on the first jaw member and the second jaw member thereby forming a bounded opening defined at the plurality of distances between the first jaw member, the second jaw member, the contact support surface, and the bolt during an assembly.

According to another alternative and adaptive aspect of the present invention, there is provided a clamping hot arm system, wherein: each the first jaw member and the second jaw member, further comprising: a jaw bottom and a jaw top, the jaw top slidably secured to the jaw bottom along a slide channel between an extended position and an engagement position, the jaw top having an extension perpendicular to the jaw bottom, a jaw spring on an outer side of the jaw top opposite the contact support surface joining the jaw bottom and the jaw top and urging the extension on the jaw top toward the contact support surface, a tooth rack having a plurality of teeth along an inner side of the jaw top opposite the jaw spring, a pivoting pawl on the jaw bottom having a pawl pivot, the pivoting pawl having a pin side with a pin profile and an opposed a tooth side with a tooth profile pivotable about the pawl pivot, and a pawl spring on the pivoting pawl urging a pawl contact surface toward the contact support surface between the first jaw member and the second jaw member whereby pin profile releasably engages the plurality of teeth on the tooth rack and restrains the jaw top in the extended position resisting the jaw spring.

According to another alternative and adaptive aspect of the present invention, there is provided a clamping hot arm system, wherein: the hot arm mounting assembly, further comprises: an adjustable hinged bracket having a first and a second mounting portion pivotably secured at a first side, a threaded bolt on the first mounting portion opposite the first side, the threaded bolt pivotably engaging with the second mounting portion opposite the first side in an interference fit, and a retaining member on the threaded bolt engaging with the second mounting portion to secure the elongate hot arm mounting assembly between an open and a closed position about the elongate hot arm member.

According to another alternative and adaptive aspect of the present invention, there is provided a clamping hot arm system, wherein: the hot arm mounting assembly, further comprises: a slidable mount having a continuous bounded member shaped for slidably receiving the elongate hot arm member, and the continuous bounded member having a plurality of bounded openings therethrough providing an access from an exterior of the continuous bounded member to an interior of the continuous bounded member.

According to another alternative and adaptive aspect of the present invention, there is provided a clamping hot arm system, wherein: the hot arm mounting assembly, further comprises: a first retaining split ring and a second retaining split ring having a common axis and joined by a cross mount, and the cross mount pivotably joined to the adaptive clamping device and pivotable in a first pivot axis perpendicular to the common axis.

According to another alternative and adaptive aspect of the present invention, there is provided a clamping hot arm system, further comprising: at least a second adaptive clamping device, at least one hot arm mounting assembly releasably securing the second adaptive clamping device to the elongate hot arm member between the first adaptive clamping device and the second end.

According to another alternative and adaptive aspect of the present invention, there is provided a clamping hot arm system, wherein: the elongate hot arm member is nonconductive.

According to another alternative and adaptive aspect of the present invention, there is provided a clamping hot arm system, further comprising: a wire holder on the elongate hot arm opposite the at least one adaptive clamping device.

According to another alternative and adaptive aspect of the present invention, there is provided a clamping hot arm system, further comprising: an adaptive bail mount system on the elongate hot arm between the at least one adaptive clamping device and the second end, and the adaptive bail mount system, further comprising: a mount bracket releasably engaged to the elongate hot arm, and a bail bracket on the mount bracket and pivotable between an engaged upright position and a retracted position.

According to another alternative and adaptive aspect of the present invention, there is provided a clamping hot arm system, wherein: the adaptive bail mount system, further comprises: a pin mount system on the mount bracket having a pin slidable relative to allow access to a receiving hole formed in the mount bracket.

According to another alternative and adaptive aspect of the present invention, there is provided a clamping hot arm system, further comprising: a support brace having a first end and an opposed second end, the support brace releasably securable to the elongate hot arm member at the first end, and the support brace having a securing mechanism at the second end.

According to another alternative and adaptive aspect of the present invention, there is provided a clamping hot arm system, further comprising: a support brace having a first end and an opposed second end, the support brace releasably securable to the elongate hot arm member at the first end, the support brace having a securing mechanism at the second end, and the support brace is nonconductive.

The above and other aspects, features and advantages of the present invention will become apparent from the following description read in conjunction with the accompanying drawings, in which like reference numerals designate the same elements. The summary is not an exhaustive overview, nor is it intended to identify key or critical elements to delineate the scope of the subject matter claimed below. Its sole purpose is to present some concepts in a simplified form as a prelude to the more detailed description set forth below.

### BRIEF DESCRIPTION OF THE DRAWINGS

The invention may be understood by reference to the following description taken in conjunction with the accompanying drawings, in which like reference numerals identify like elements.

FIG. 1 is an illustration of an adaptive hot arm according to one embodiment of the present invention.

FIG. 2 is a close perspective view of an adaptive embodiment related to FIG. 1.

FIG. 3 is another alternative arrangement of an adaptive hot arm system according to a further embodiment of the present invention.

FIG. 4 is a close perspective view of an adaptive embodiment related to FIG. 3.

FIGS. 5 through 8 are views of an alternative embodiment of an adaptive bail mount system and an adaptive pin mount system.

FIGS. 9 through 12 are illustrations of alternative embodiments of adaptive clamping devices and system arrangements according to the present invention.

FIG. 13 is a section along section 13-13 in FIG. 12.

FIGS. 14-26 are illustrations of alternative embodiments of adaptive clamping devices and system arrangements in use according to the present invention.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Wherever possible, same or similar reference numerals are used in the drawings and the description to refer to the same or like parts or steps. The drawings are in simplified form and are not to precise scale. The word ‘couple’, ‘connect’, ‘join’, or ‘link’ and similar terms do not necessarily denote direct and immediate connections, but also include connections through intermediate elements, apparatus, or devices. For purposes of convenience and clarity only, directional (up/down, in/out etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

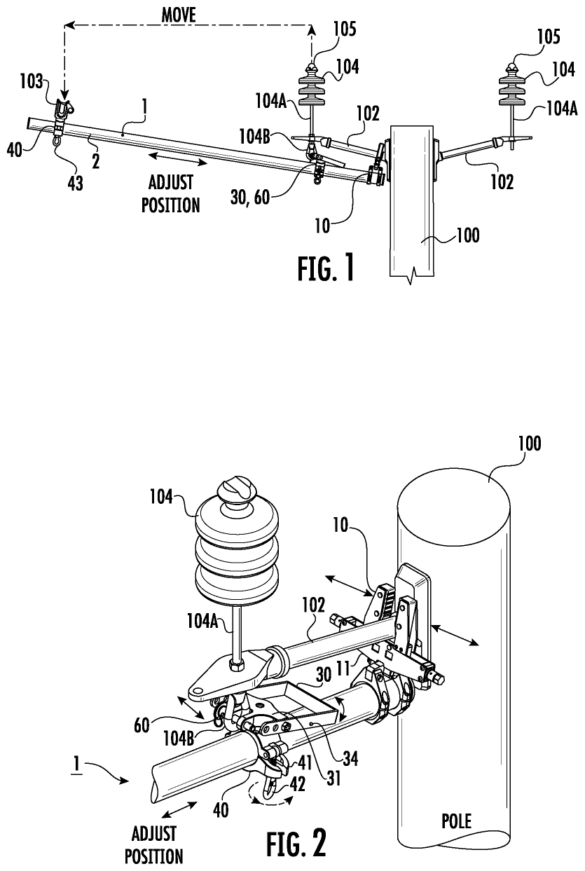

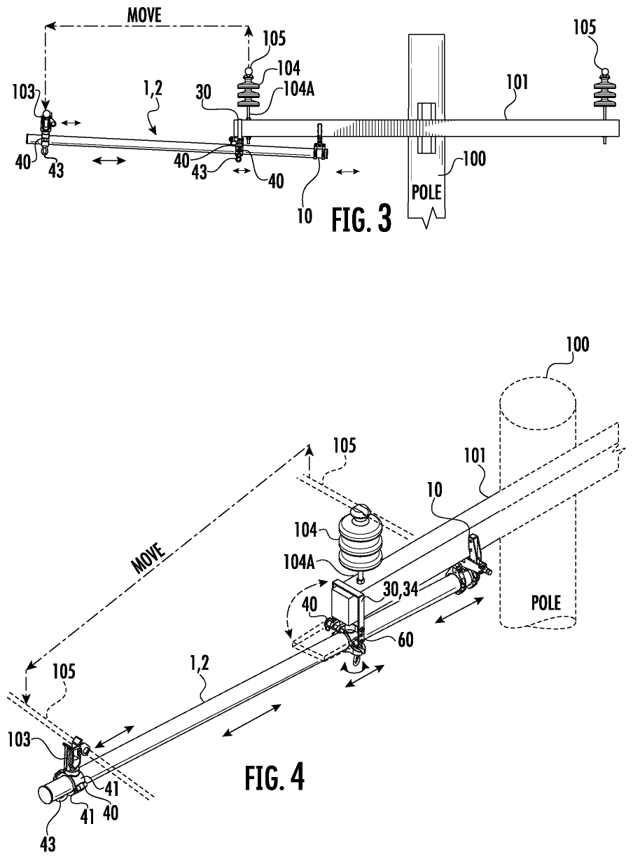

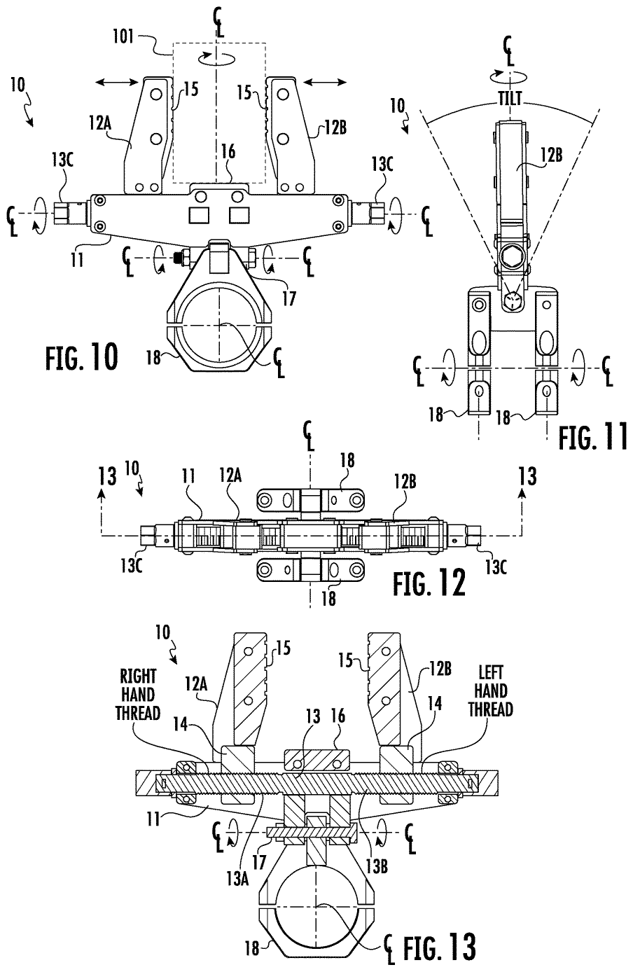

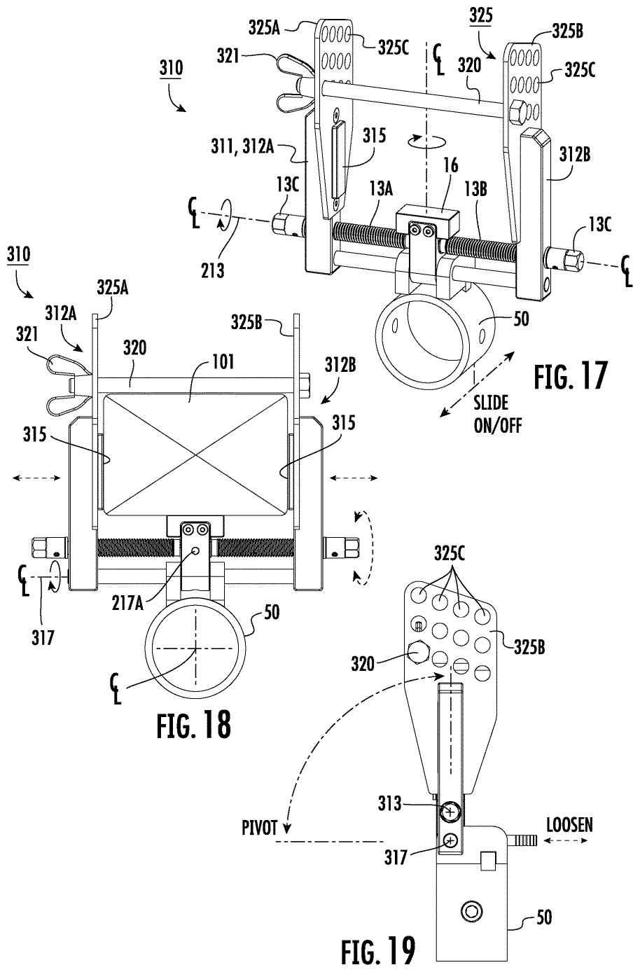

Referring now to FIGS. 1 through 26 wherein an adaptive hot arm system 1 is provided for use during interaction (repair, maintenance, installation) with a utility pole 100 provided with either a cross arm 101 or a standoff arm 102, as shown. An insulator 104 is provided for supporting a conductor 105 and, in the illustrations the insulator 104 extends from either cross arm 101 or standoff arm 102 by means of a supporting insulation shaft 104A spacing the insulator 104 from the supporting cross arm 101 or standoff arm 102. In select embodiments, insulation shaft 104A continues through the respective cross arm 101 or beyond standoff arm 102, and further ends with a rigging hole member 104B, as shown. Rigging hole member 104B is a rigid member having a hole and allowing attachment therewith during installation or for other repair.

As will be understood from the present disclosure, utility pole 100, cross arm 101, standoff arm 102, and respective insulator 104 and related shaft 104A etc. may be made from any suitable material conventionally used, including without limitation wood, fiberglass, alone or in combination with metal (e.g., the utility pole 101 may be metal, with a cross arm 101 of metal, but using a non-conductive cross arm 101 or standoff arm 102 with insulator 104) as will be understood by those of skill in the conventional electrical transmission construction and electrical rigging arts.

An innovation noted herein is a support brace 101A (see additionally FIG. 21) which secures pole 100 to cross arm 101 by use of a restraining belt and ratchet system 101B and accordingly aids in temporarily supporting heavy loads applied to hot arm system 1 or hart arm member 2. The inclusion of support brace 101A and restraining belt and ratchet system 101B link with a pivot connection 101C to allow for adjustment and positioning.

Adaptive hot arm system 1 includes a hot arm member 2 as discussed herein, formed preferably of a nonconductive elongated member, optionally a cylindraceous member, for example of fiberglass or other material, but not limited thereto, and may be foam filled or empty with end caps to prevent moisture incursion or air incursion to an interior and so as to provide an improved non-conductive hot arm member 2.

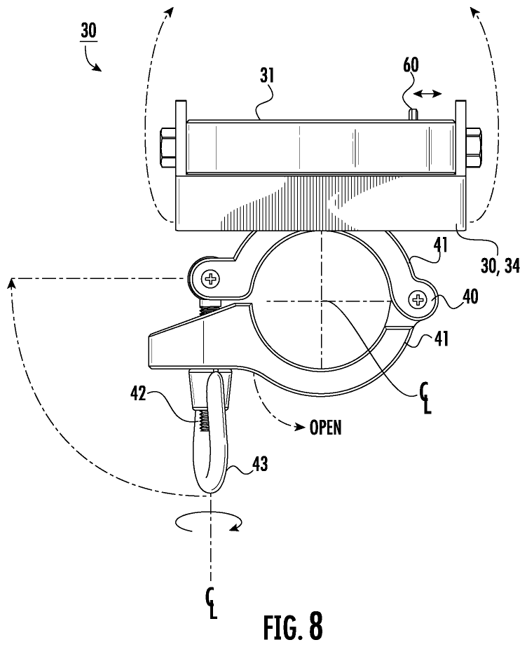

At one end of adaptive hot arm system 1 is provided a wire holder 103 for receiving and temporarily retaining conductor 105 displaced from insulator 104 during repair or installation. Wire holder 103 is slidable and adjustable relative to the length of hot arm member 2 by the use of an adjustable hinged bracket 40, as discussed herein (See FIG. 8) with hinged mount portions 41, 41 hingably linked by a hinge (as shown, not numbered) and with a shape allowing a pivoting threaded bolt 42 to be restrained through adjustment of a corresponding tensioning rigging hole member 43 (as shown), so as to allow respective portions 41, 41 to be tensioned together and fix wire holder 103 to hot arm member 2 as desired. It will be recognized, having appreciated the disclosure herein, that by adjustment respective portions 41, 41, may be loosened and wire holder 103 may be slidably adjusted along a length of, and about the outer surface of, hot arm member 2 and adaptive hot arm system 1 to allow suitable adjustment during use for improved user safety and functionality.

At an opposite end of adaptive hot arm system 1 and hot arm member 2 from wire holder 103 is an adaptive clamping device 10, slidably adjustable in a secure manner along a length of hot arm member 2 and about an outer surface of hot arm member 2 by a mounting bracket assembly 18. Mounting bracket 18 formed of a first split ring 18A and a second split ring 18B joined by a cross mount 18C, in this preferred but non-limiting embodiment, is provided with two sets of spaced apart ring-portions (shown) that are threadably joined by threaded member (shown, not numbered) which allow adaptive clamping device 10 to be adjustably moved along, and rotated relative to, hot arm member 2 and adaptive hot arm system 1 as will be appreciated by those of skill in the art having appreciated the disclosure herein.

Positioned adaptively between wire holder 103 and adaptive clamping device 10 is an adaptive bail mount system 30 and an adaptive pin mount system 60 as shown herein. While not required, in the present embodiment, both adaptive bail mount system 30 and adaptive pin mount system 60 are jointly mounted on a mount bracket 31 having a connective pivot 32 to a respective adjustable hinged bracket 40 with hinged mounting portions 41, 41, secured by a threaded bolt 42 having a preferred tensioning rigging hole member 43. By adjusting the tension on threaded bolt 42 along the length of or about an outer radial position of hot arm 2 mount bracket 31 may be positioned at any convenient location relative to a desired cross arm 101 or standoff arm 102 that is secured within adaptive clamping device 10. Additionally, it will be understood that connective pivot 32 allows a relative rotation of mount bracket 31 to adjustable hinged bracket 40 to allow an off angle position as may be desired during field or other repair conditions.

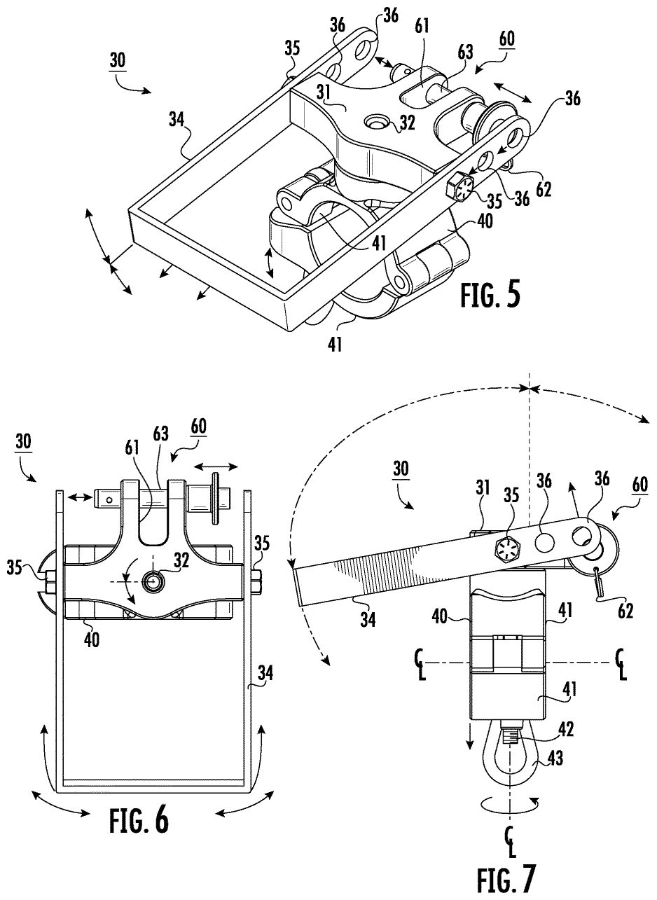

Adaptive bail mount system 30 includes a bail bracket 34 shaped in a form suitable to pivot up to engage an end of either cross arm 101 or standoff arm 102 as may be decided by an end user and the relative configurations of cross arm 101 and stand off arm 102 without departing from the scope and spirit of the present invention. As shown particularly in FIG. 4, bail bracket 34 is rotated relative to a pivot axis 35 releasably fixable by a threaded bolt (shown) and may be fixed in an upright or other tilt angle (see FIG. 7 also) as may be desired in the field.

As will be appreciated by review of FIGS. 5 and 6, bail bracket 34 includes additional adjustment holes 36, 36 on the extended portions beyond pivot axis 35; and accordingly at need, the respective threaded bolts (shown) at pivot axis 35 may be removed, bail bracket 34 extended further (e.g., for larger dimensioned cross arms 101) and the threaded bolts replaced and secured and the adaptive bail mount system 30 redeployed for ongoing use. In this manner, it will be appreciated in the art that adaptive bail mount system 10 is adjustable by tilt rotation, by pivot rotation, and by length adjustment, and further by replacement with a differently shaped bail bracket 34 (e.g., an extended profile, rounded top profile, narrow top profile, stepped shape profile or otherwise as may be suitable to readily adapt to alternatively shaped cross arms 101 or standoff arms 102 without departing from the scope and spirit of the present invention).

Adaptive pin mount system 60 is similar mounted to hot arm 102 of adaptive hot arm system 1 via adjustable hinged bracket 40 as shown and further extends from mount bracket 31 in the form of a spaced pin-arrangement (See FIGS. 5-6) wherein a sliding pin 63 with a grip-side (shown) and a lock side (shown) having a clevis hole 61 for locking arrangement to receive a clevis pin 62. In use, hot arm 2 is locked to a cross arm 101 or standoff arm 102 via adaptive clamping device 10, as shown and, in the particular arrangement rigging hole member 104B provides an opening positioned proximate the respective opening in adaptive point mount system 60, wherein, upon a lateral sliding of sliding pin 63, the rigging hole member 104B may be positioned between the extending members (shown but not numbered) and sliding pin 63 slid therethrough for locking retainment, further secured by clevis pin 62 installation in clevis hole 61. As a result, adaptive pin mount system 60 is securely affixed to respective rigging hole member 104B on either standoff arm 102 or on cross arm 101 as may be the case in the operating field. For removal, a user removes clevis pin 62, pulls clevis pin 63, releasing rigging hole member 104B, and freeing hot arm 2 of adaptive hot arm system 1 from standoff arm 102 or cross arm 101.

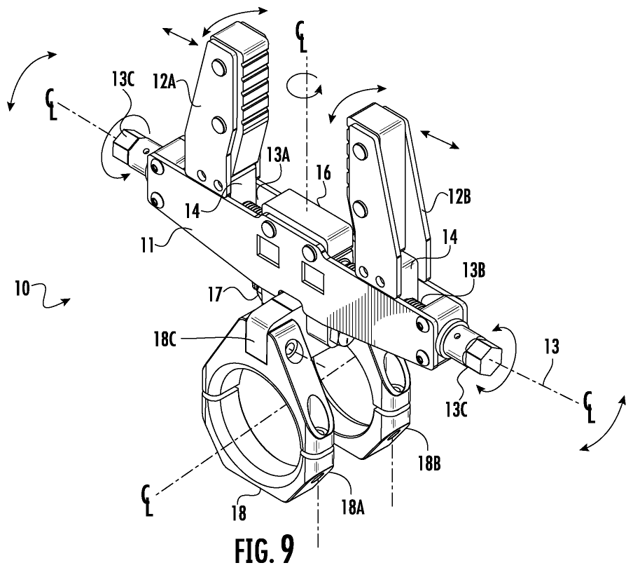

Referring, additionally, to FIGS. 9 through 26 alternative and adaptive clamping systems and devices are discussed that may adaptively be used with the proposed bail mount system 30 in a suitable situation to aid in safe operations.

Extending from mounting bracket assembly 18 for adaptive clamping device 10 is a jaw assembly 11 with adjustable jaws 12A, 12B (adaptively referred to as adjustable jaw systems 12A, 12B or the jaw system etc., as shown, adjustable relative thereto by a driving axle 13 as will be explained and also optionally by a pivot bolt arrangement 17, allowing both a relative tilt of jaw assembly 11 to the length-direction of hot arm member 2 (e.g., along an axis of pivot bolt arrangement 17 and also a rotation relative to mounting bracket 18 so that jaw assembly 11 may be loosened, and twisted or adjusted and thus may be off set at an angle radian to hit arm member 2, as shown, and re-secured by tightening mounting bracket 18 and pivot bolt arrangement 17 in combination for improved safety and suitability during use so that driving axle 13 may be positioned to allow for movement of jaws 12A, 12B, as adjustable jaw systems, for clamping.

In adaptive clamping device 10, jaw assembly 11 includes a driving axle 13 having left-hand 13A and right hand 13B threaded sections guiding respective carrier nuts 14, 14 which in turn threadably drive respective jaws 12A, 12B, as shown during a rotation. Opposed ends of driving axle 13 are formed for convenience with hex-shape ends 13C, 13C but is not limited to this shape and any shape may be used sufficient to operate driving axle 13 thereto. Jaws 12A, 12B feature optional replaceable jaw surfaces 15, 15 that are operably constructed from elastomeric, nonmetallic, or nonconductive material (such as plastic, fiberglass, HDPE, EPDM, or other solid polymers or cellulose base (wood fiber, wood and polymer mix or otherwise) or other non-conductive material) for ease of use and ready replacement. Positioned between respective jaws 12A, 12B on jaw assembly 11 is a supporting contact surface 16 that optionally also may have a layer or be constructed from a material similar to the replaceable jaw surfaces 15, 15. As can be appreciated upon consideration and understanding of the present inventive disclosure, a user may operate driving axle 13 by hand, by pneumatic, by electropneumatic, by electro-impact, or other driver or mechanical means so as to rapidly tighten and loosen respective jaws 12A, 12B toward or away from each other so as to correspondingly tightly fix to or lose from cross arm 101 or standoff arm 102 during a use. Similarly, pivot bolt 17 may be tightened or loosened relative to adaptive hot arm system 1 for suitable positioning.

During use and assembly, adaptive clamping device 10, on adaptive hot arm system 1 and/or hot arm 2 is secured to cross arm 101 or standoff arm 102, as shown, and tightened by rotation of driving axle 13 thereby clinching jaws 12A, 12B to the respective arm 101, 102. As further shown (but not numbered) jaws 12A, 12B and respective jaw surfaces 15, 15 may have a non-linear profile, or a non-smooth profile, or roughened profile to provide an enhanced gripping of round surfaces, angular, or other non-standard and non-linear surfaces for either cross arm 101 or standoff arm 102. For example if standoff arm 102 is round, a tapered surface on jaws 12A, 12B securely positions the standoff arm 102 between respective jaws and contact surface 16 to prevent slippage during use.

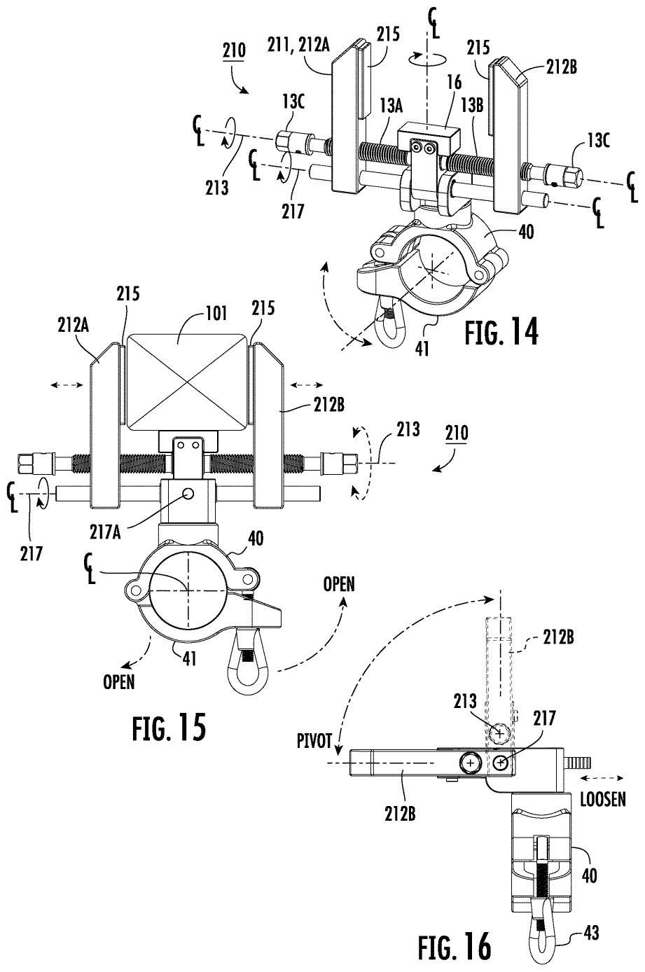

Additionally referring now to FIGS. 14-26 additional hot arm clamping systems and adaptive clamping devices for use are provided wherein additional clamping devices and systems are noted as adaptive clamping device 210, 310, and 410 as will be discussed.

An alternative embodiment is noted herein as an adaptive clamping device and system 210 (additionally referring now to FIGS. 14-16) is shown in adaptive combination with an adjustable hinged bracket 40 (previously discussed in FIGS. 5-8) for slidable adjustment along and about a hot arm member 1, 2 (for example in a manner as shown in FIG. 4). Clamping system 210 includes, jaw assembly 212 with respective jaws 212A, 212B along a driving axle 213 as shown with respective threaded sections 13A, 13B as previously discussed to allow for relative movement. Jaw surfaces 215, 215 are shown on jaws 212A, 212B to aid in gripping an exemplary cross arm 101 shown in cross section (FIG. 15). A pivot axis 217 adjusted for motion by a pivot adjust bolt 217A (e.g., a threaded member), allows for jaw assembly 211 to pivot relative to adjustable hinged bracket 40 (as shown in FIG. 16) for ready positioning between uses or to allow for avoidance of interference. As will be further noted herein, jaw surfaces 215, 215 on respective jaws 212A, 212B may be of any suitable material or form as discussed herein. In this manner, adaptive clamping system 210 will be understood to be related to adaptive clamping device and system 10 and may be referred to and modifiable thereto within the scope and spirit of the present invention.

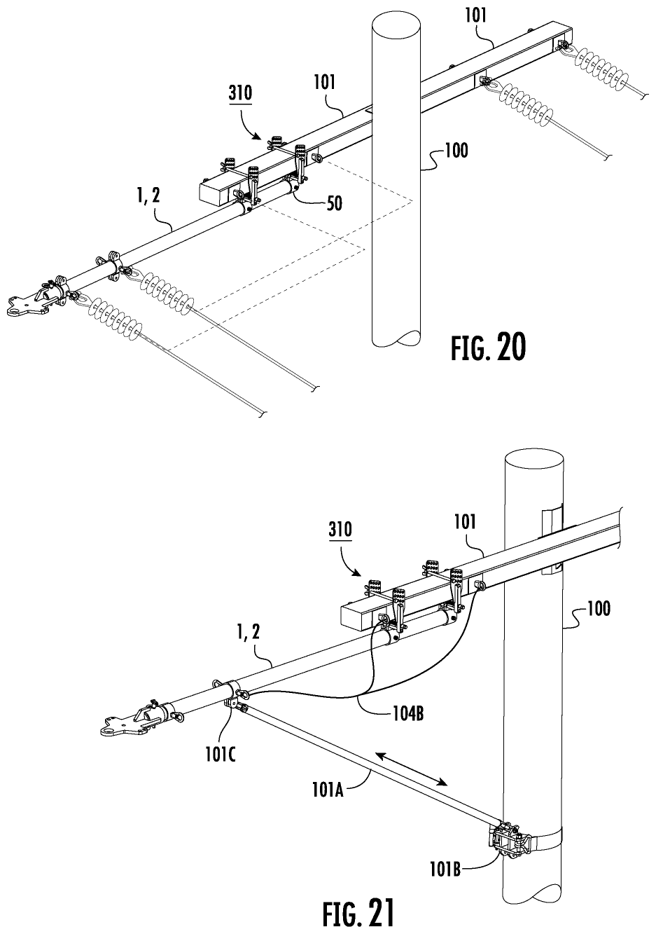

Referring additionally to an adaptive alternative embodiment of an adaptive clamping device and system 310 (additionally referring not to FIGS. 17-21) is shown in adaptive combination with a slidable mount 50 with one or more bounded openings 51 (that is slidable on, in this exemplary embodiment, a round hot arm 1, 2 as shown in embodiment 4 with openings for attaching bolts or threated members therethrough). The jaw assembly 311 includes jaw members 312A, 312B each movable along a driving axle 312 in a manner similar to that in the related embodiments using threaded carrier nuts (as in FIG. 13, but not shown in FIGS. 17-19) so that a driving force on hex ends 13C will drive jaws 312A, 312B relative to each other. A jaw surface 315 is noted on each respective jaw for gripping an exemplary cross arm member 101 as shown on contact surface 16. As noted similarly, a pivot axis 317 is provided controllable by a pivot adjustment bolt 317A and allows adaptive clamping device 310 to pivot relative to slidable mount 50. An additional adaptation is provided herein wherein a jaw engagement system 325 is provided with jaw brackets 325A, 325B on each respective jaw 312A, 312B. Each jaw bracket 325A, 325B is removably secured to the respective jaw and includes a plurality of holes 325C at different distances from support contact surface 16 for receipt of a bolt 320 having a wing nut 321 as shown. As a result, in a use, adaptive clamping device 312 may be pivoted upwardly into position relative to a cross arm member 101, clamped thereto by driving drive axle 313 via respective hex drive ends 13C to urge jaws 312A, 312B together, and when secure, an additional safety step is provided by aiding with the insertion of bolt 320 through a respective hole 325C to closely secure respective jaw brackets 325A, 325B on either side of cross arm 101 so that a four-sided contact is made on cross arm 101 so that the provided hot arm clamping system provided herein may support additional weight that is cantilevered outwardly from utility pole 100, for example as shown in FIGS. 20, 21. In this manner, one or more adaptive clamping devices 310, 310 or a plurality of other adaptive clamping devices as disclosed herein, may be used, optionally in combination with support brace 101A to support a larger weight that is spaced from utility pole 100 along cross arm 101. This arrangement, and others that will be readily understood from appreciation of the entire scope of the present invention allows for both weight support in both a X-direction (e.g., along the respective direction of driving axle 313) and in a Y-direction (which is perpendicular to the X-direction and restrains cross arm 101) and resistance of directional forces that may occur during line work.

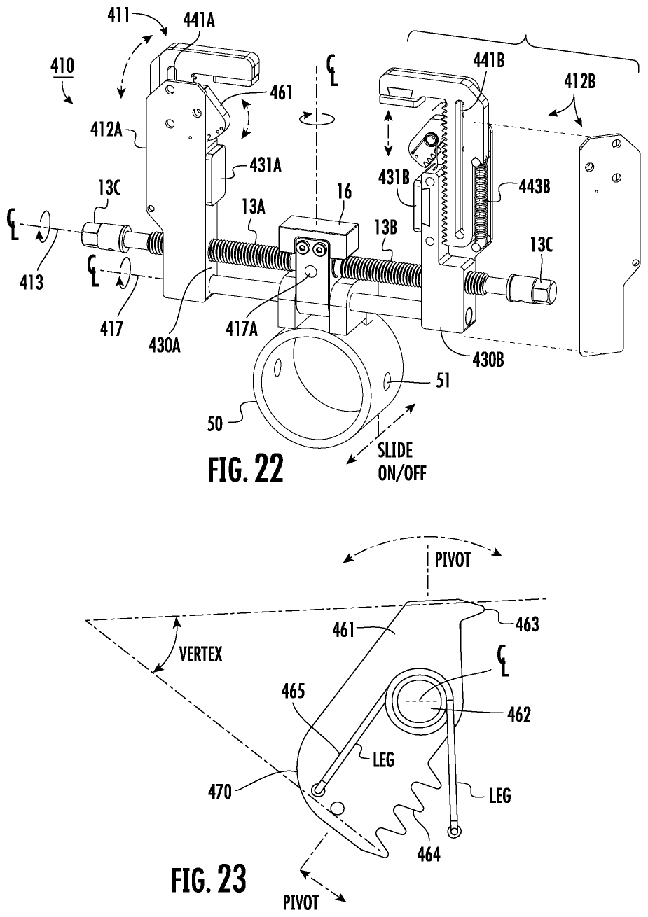

Additionally referring now to FIGS. 22 to 26 a further adaptive clamping device and system 410 is provided with a jaw assembly 411 having jaw members 412A, 412B as will be discussed. Jaw members 412A, 412B are threadably driven by driving axle 413 with respective left-and-right hand threads 13A, 13B as discussed herein above. A pivot axis 417 is provided controlled by a pivot adjust bolt 417A so as to allow a pivoting of adaptive clamping device 410 relative to slidable mount 50 for ease of convenience. By driving the driving axle 412, each jaw member 412A, 412B which is threadably secured to respective threaded sections 13A, 13B is driven toward or away from each other and cross arm 101 in an X-direction as will be understood by rotating hex end 13C Each jaw member 412A, 412B is provided with a jaw bottom member 430A, 430B having respective jaw side contact members 431A, 431B for side contacting cross arm 101 as shown (FIG. 25). Each jaw side contact member 431A, 431B is made of a suitable material as discussed herein above, including but not limited to elastomeric materials, rubbers, or plastics, and has a uniform thickness on either jaw member 412A, 412B.

Each jaw bottom 430A, 430B is slidably linked to a respective jaw top 440A, 440B. The slide linkage includes a slide channel 441A, 441B and respective slide pins 442A, 442B that slide in each respective channel. FIGS. 22, 24, 25, and 26 are understood to be shown with one jaw side cover removed so as to allow appreciation of the respective components herein. Respective springs A, 443B link respective jaw tops 440A, 440B and jaw bottoms 430A, 430B and provide an urging force urging the sliding together of the tops-and-bottoms. Springs 443A, 443B are on the outer sides of respective jaw member 412A, 412B as shown away from support contact surface 16. A jaw top contact member 444A, 444B is on each respective jaw top 440A, 440B for contacting a top of cross arm 101 (see FIG. 26) during a use. Jaw top contact members 444A, 444B are formed of similar materials as jaw side contact member 413A, 413B. Jaw top contact members 444A, 444B project perpendicularly from jaw bottoms 430A, 430B, as shown, to engage in a Y-direction during a use (toward and away from contact surface 16) as will be discussed.

On an inner surface facing contact surface 16, of each jaw top 440A, 440B is a toothed rack with a plurality of evenly spaced teeth 460 that are urged by respective springs 443A, 443B toward jaw bottoms 430A, 430B. Proximate a top portion of each respective jaw bottom 430A, 430B is a pivoting pawl member 461. Each pawl member 461 is pivotably secured to the top portion of each respective jaw bottom 430A, 430B and has a pivot axis 462 allowing pawls 461 to pivot about pivot axis 462. A spring member 465 is fixed on each pawl 461 and has opposing legs (legs shown but not numbered) with one leg fixed to each pawl 461 and a free-leg in contact with the respective jaw bottom 430A, 430B to provide an outward urging of pawl 461 away from teeth 460 on each respective jaw top 440A, 440B. Pawl 461 has two opposed side opposite pivot axis 462, a pin-side 463 having a single tooth-shape, formed to fit within respective teeth 460, and a tooth-side 464 having a plurality of tooth-shapes, formed to fit within respective teeth 460 depending upon which direction pawl 461 is pivoted.

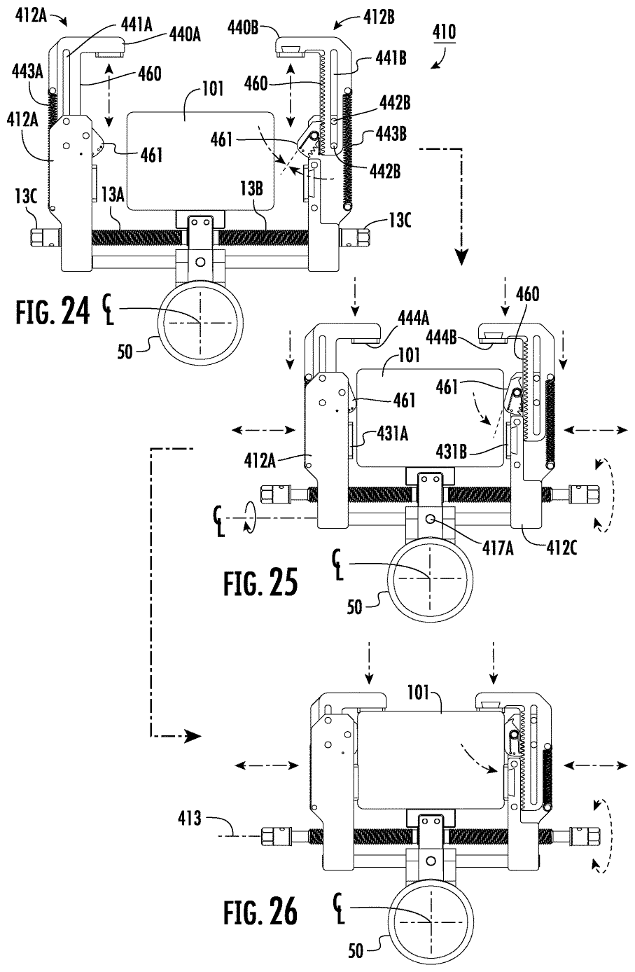

As shown in FIGS. 22 and 24, when a cross arm 101 is positioned on contact surface 16 and respective jaws 412A, 412B are spaced therefrom, springs 465 urge respective pawls 461 outwardly, so that upon pivoting pin sides 463 engage respective teeth 460 on each respective jaw tops 440A, 440B, and as a result resist the compacting urge of springs 443A, 443B on either side thereof so that a user may ‘draw up’ each jaw top 440A, 440B away from contact surface 16 for a pre-use condition and upwardly away from respective jaw bottoms 430A, 430B.

Next adaptive clamping device 440 is positioned on cross arm 101 and driving axle 413 is rotated via a hex end 13C and jaws 412A, 412B approach each other in the X-direction along respective threaded sections 13A, 13B until a contact profile 470 of each pawl 461 contacts the cross arm 101 and a rotates pawl 461 about pivot axis 462 against the outer urging of each pawl spring 465 to disengage each pin side 463 (e.g., pin 463) from a respective tooth of the teeth 460, 460 on each jaw top 440A, 440B, and upon a disengagement of pins 463, springs 443A, 443B urge a contraction-spring contact in the Y-direction toward contact surface 16 with respective jaw top contact members 444A, 444B and the top of cross arm 101 while simultaneously tooth side teeth 464 of each pawl 461 continue upon the pivoting motion about respective pivot axes 462 to engage with the teeth 460, 460 on each respective jaw top 440A, 440B (See FIGS. 25-26). Therefore, as diving axle 413 continues to rotate, and respective left-and-right threaded sections 13A, 13B drive jaws 412A, 412B toward each other, upon contact with cross arm 101 in the initial X-direction, the proposed adaptive clamping device 410 additionally causes a clamping contact in the perpendicular Y-direction securing cross arm 101 in both X-and-Y directions between opposing jaw members 412A, 412B (with jaw top contact members 444A, 444B) and contact surface 16 for enhanced securement. It will be understood that the present embodiment may be similarly used on standoff arms 102 without departing from the scope and spirit of the present invention.

In this way the adaptive hot arm system 1, with alternative adaptive clamping device systems 10, 310, 310, 410 and adaptive bail mount system 30 and respective securing mounts 18, 40, and 50, allows rapid adaptation to alternative field conditions, unusual and alternative arrangements for utility pole 100, cross arms 101, and standoff arms 102 with insulators 104 as will be appreciated by those of skill in the art having studied the entire disclosure.

As used herein the phrases elastomeric, elastomeric materials, rubber, or plastic will be understood to be adaptively selected from materials having a hardness less than that of conventional metal (iron, aluminum, related alloys etc.) and having an electrical resistive property or a nonconductive property (e.g., lower electrical conductivity then metals such as fiberglass, rubber, plastic, polymers, carbon alloys, or other fiber-composite materials). As a result, for example, as used herein the clamping assembly jaws having replaceable faces or teeth may be made from a suitable gripping material that is suitable for that purpose, whereas the fiberglass used in the rigid hot arm is not elastomeric but does have very low electrical conductivity. Those of skill in this hart, having studied and appreciated the entire disclosure herein may readily appreciate the suitability of materials selection according to the needs set forth herein without departing from the scope and spirit of the present disclosure.

As will be understood by those of skill in the art, having studied and appreciated the disclosure herein, the provided support head assemblies each involve a pivoting means for pivoting respective insulating rollers between an open and a closed position without departing from the scope and spirit herein nor the elements and limitations herein.

One or more specific embodiments of the present invention will be described below. The present invention is not limited to the embodiments and illustrations contained herein, but include modified forms of those embodiments including portions of the embodiments and combinations of elements of different embodiments as come within the scope of the appended claims. In the development of any such actual implementation, as in any engineering or design project, numerous implementation-specific decisions must be made to achieve the developers' specific goals, such as compliance with specific material-requirement (e.g., a capacitance, voltage, or insulative limitation or a strength or durability requirement to address heavy stress environments).

Furthermore, the phrase “capable of” as used herein is a recognition of the fact that some functions described for the various parts of the disclosed apparatus are performed only when the apparatus is in operation. Those in the art having the benefit of this disclosure will appreciate that the embodiments illustrated herein may be additionally coupled with a powered closing mechanism without departing from the scope and spirit of the present invention.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A clamping hot arm system, for engaging a cross arm, comprising:
an adaptive clamping device, further comprising:
an adjustable jaw assembly having a first jaw member and a second jaw member;
a driving axle extending along a first pivot axis through a contact support surface between said first jaw member and said second jaw member;
said driving axle having a left-hand threaded section and a right-hand threaded section;
a first threaded carrier in said first jaw member driven by said left-hand threaded section and a second threaded carrier in said second jaw member driven by said right-hand threaded section whereby a rotation of said driving axle drives an opening or a closing of said adjustable jaw assembly; and
each said first jaw member and said second jaw member, further comprising:
a jaw bottom and a jaw top;
said jaw top slidably secured to said jaw bottom along a slide channel between an extended position and an engagement position;
said jaw top having an extension perpendicular to said jaw bottom;
a jaw spring on an outer side of said jaw top opposite said contact support surface joining said jaw bottom and said jaw top and urging said extension on said jaw top toward said contact support surface;
a tooth rack having a plurality of teeth along an inner side of said jaw top opposite said jaw spring;
a pivoting pawl on said jaw bottom having a pawl pivot;
said pivoting pawl having a pin side with a pin profile and an opposed a tooth side with a tooth profile pivotable about said pawl pivot; and
a pawl spring on said pivoting pawl urging a pawl contact surface toward said contact support surface between said first jaw member and said second jaw member whereby pin profile releasably engages said plurality of teeth on said tooth rack and restrains said jaw top in said extended position resisting said jaw spring.

2. The clamping hot arm system, according to claim 1, wherein:
said pivoting pawl is pivotable about said pawl pivot to compress said pawl spring and to release said pin profile from said plurality of teeth on said jaw top, whereby said jaw spring urges said extension on said top jaw to said engagement position.

3. The clamping hot arm system, according to claim 2, wherein:
said tooth profile on said pivoting pawl releasably engages with said tooth rack on said inner side of said jaw top at said engagement position thereby preventing said jaw top from moving away from said contact support surface.

4. The clamping hot arm system, according to claim 3, further comprising:
a jaw side contact member on each said jaw bottom projecting toward said contact support surface; and
said jaw side contact member being an electrically resistive material.

5. The clamping hot arm system, according to claim 3, further comprising:
a jaw top contact member on each said extension of each said jaw top projecting toward said contact support surface; and
said jaw top contact member being an electrically resistive material.

6. The clamping hot arm system, according to claim 3, further comprising:
a jaw side contact member on each said jaw bottom projecting toward said contact support surface;
said jaw side contact member being an elastomeric material;
a jaw top contact member on each said extension of each said jaw top projecting toward said contact support surface; and
said jaw top contact member being an elastomeric material.

7. The hot arm clamping system, according to claim 3, wherein:
said pawl contact surface on said pivoting pawl is a convex curved surface projecting away from said tooth side and from said tooth profile.

8. The hot arm clamping system, according to claim 7, wherein;
said pin profile projects in a first direction and said tooth profile projects in a second direction and said first direction and said second direction form an acute angle with a vertex on the same side of said pawl pivot as said pawl contact surface; and
whereby when said pivoting pawl pivots from an engagement of said tooth rack with said pin profile to an engagement of said tooth rack with tooth profile, said jaw spring urges said jaw top to slide between said extended position and said engagement position.

9. A hot arm clamping system, according to claim 3, further comprising:
a pair of opposed driving ends on respective opposing sides of said driving axel; and
each said driving end having an engagement profile for an engagement and applying of a rotational drive force about said driving axel whereby said rotation of said driving axle drives said opening or said closing of said adjustable jaw assembly.

10. A hot arm clamping system, according to claim 3, further comprising:
a hot arm mounting assembly;
said hot arm mounting assembly pivotably secured to said adaptive clamping device and releasably securable movable between an engagement position and a storage position.

11. The hot arm clamping system, according to claim 8, wherein:
said hot arm mounting assembly, further comprises:
an adjustable hinged bracket having a first and a second mounting portion pivotably secured at a first side;
a threaded bolt on said first mounting portion opposite said first side;
said threaded bolt pivotably engaging with said second mounting portion opposite said first side in an interference fit; and
a retaining member on said threaded bolt engaging with said second mounting portion to secure said hot arm mounting assembly between an open and a closed position.

12. The hot arm clamping system, according to claim 10, wherein:
said hot arm mounting assembly, further comprises:
a slidable mount having a continuous bounded member shaped for receiving a hot arm; and
said continuous bounded member having a plurality of bounded openings therethrough providing an access from an exterior of said continuous bounded member to an interior of said continuous bounded member.

13. The hot arm clamping system, according to claim 10, wherein:
said hot arm mounting assembly, further comprises:
a first retaining split ring and a second retaining split ring having a common axis and joined by a cross mount; and
said cross mount pivotably joined to said adaptive clamping device and pivotable in a first pivot axis perpendicular to said common axis.

14. A clamping hot arm system, for engaging a cross arm, comprising:
an adaptive clamping device, further comprising:
an adjustable jaw assembly having a first jaw member and a second jaw member;
a driving axle extending along a first pivot axis through a contact support surface between said first jaw member and said second jaw member;
said driving axle having a left-hand threaded section and a right-hand threaded section;
a first threaded carrier in said first jaw member driven by said left-hand threaded section and a second threaded carrier in said second jaw member driven by said right-hand threaded section whereby a rotation of said driving axle drives an opening or a closing of said adjustable jaw assembly; and
each said first jaw member and said second jaw member, further comprising:
a jaw bottom and a jaw top;
said jaw top slidably secured to said jaw bottom along a slide channel between an extended position and an engagement position;
said jaw top having an extension perpendicular to said jaw bottom;
a jaw spring on an outer side of said jaw top opposite said contact support surface joining said jaw bottom and said jaw top and urging said extension on said jaw top toward said contact support surface;
a tooth rack having a plurality of teeth along an inner side of said jaw top opposite said jaw spring;
a pivoting pawl on said jaw bottom having a pawl pivot;
said pivoting pawl having a pin side with a pin profile and an opposed a tooth side with a tooth profile pivotable about said pawl pivot;
a pawl spring on said pivoting pawl urging a pawl contact surface toward said contact support surface between said first jaw member and said second jaw member whereby pin profile releasably engages said plurality of teeth on said tooth rack and restrains said jaw top in said extended position resisting said jaw spring;
said pivoting pawl is pivotable about said pawl pivot to compress said pawl spring and to release said pin profile from said plurality of teeth on said jaw top, whereby said jaw spring urges said extension on said top jaw to said engagement position; and
said tooth profile on said pivoting pawl releasably engages with said tooth rack on said inner side of said jaw top at said engagement position and prevents said jaw top from moving away from said contact support surface.

15. A clamping hot arm system, according to claim 14, wherein:
said pawl contact surface on said pivoting pawl is a convex curved surface projecting away from said tooth side and from said tooth profile.

16. The hot arm clamping system, according to claim 15, wherein;
said pin profile projects in a first direction and said tooth profile projects in a second direction and said first direction and said second direction form an acute angle with a vertex on the same side of said pawl pivot as said pawl contact surface; and
whereby when said pivoting pawl pivots from an engagement of said tooth rack with said pin profile to an engagement of said tooth rack with tooth profile, said jaw spring urges said jaw top to slide between said extended position and said engagement position.

17. A hot arm clamping system, according to claim 16, further comprising:
a pair of opposed driving ends on respective opposing sides of said driving axel; and
each said driving end having an engagement profile for an engagement and applying of a rotational drive force about said driving axel whereby said rotation of said driving axle drives said opening or said closing of said adjustable jaw assembly.

18. A clamping hot arm system, for engaging a cross arm, comprising:
an adaptive clamping device, further comprising:
an adjustable jaw assembly having a first jaw member and a second jaw member;
a driving axle extending along a first pivot axis through a contact support surface between said first jaw member and said second jaw member;
said driving axle having a left-hand threaded section and a right-hand threaded section;
a first threaded carrier in said first jaw member driven by said left-hand threaded section and a second threaded carrier in said second jaw member driven by said right-hand threaded section whereby a rotation of said driving axle drives an opening or a closing of said adjustable jaw assembly; and
each said first jaw member and said second jaw member, further comprising:
a jaw bottom and a jaw top;
said jaw top slidably secured to said jaw bottom along a slide channel between an extended position and an engagement position;
said jaw top having an extension perpendicular to said jaw bottom;
a jaw spring on an outer side of said jaw top opposite said contact support surface joining said jaw bottom and said jaw top and urging said extension on said jaw top toward said contact support surface;
a tooth rack having a plurality of teeth along an inner side of said jaw top opposite said jaw spring;
a pivoting pawl on said jaw bottom having a pawl pivot;
said pivoting pawl having a pin side with a pin profile and an opposed a tooth side with a tooth profile pivotable about said pawl pivot;
a pawl spring on said pivoting pawl urging a pawl contact surface toward said contact support surface between said first jaw member and said second jaw member whereby pin profile releasably engages said plurality of teeth on said tooth rack and restrains said jaw top in said extended position resisting said jaw spring;
said pivoting pawl is pivotable about said pawl pivot to compress said pawl spring and to release said pin profile from said plurality of teeth on said jaw top, whereby said jaw spring urges said extension on said top jaw to said engagement position;
said tooth profile on said pivoting pawl releasably engages with said tooth rack on said inner side of said jaw top at said engagement position and prevents said jaw top from moving away from said contact support surface;
wherein said pawl contact surface on said pivoting pawl is a convex curved surface projecting away from said tooth side and from said tooth profile;
said pin profile projects in a first direction and said tooth profile projects in a second direction and said first direction and said second direction form an acute angle with a vertex on the same side of said pawl pivot as said pawl contact surface; and
whereby when said pivoting pawl pivots from an engagement of said tooth rack with said pin profile to an engagement of said tooth rack with tooth profile, said jaw spring urges said jaw top to slide between said extended position and said engagement position.
